(19) United States
(12) Patent Application Publication
(10) Pub. No.: US 2017/0083917 A1
(43) Pub. Date: Mar. 23, 2017

(54) SYSTEM AND METHOD FOR AUTHORIZING TRANSACTIONS

(71) Applicant: EZIC Inc., Vernon Hills, IL (US)

(72) Inventor: Fredrik Sjoholm, Newport Coast, CA (US)

(21) Appl. No.: 15/271,636

(22) Filed: Sep. 21, 2016

Related U.S. Application Data
(60) Provisional application No. 62/221,243, filed on Sep. 21, 2015.

(51) Int. Cl. G06Q 20/40; G06Q 20/34

(52) U.S. Cl. CPC G06Q 20/4014; G06Q 20/4016; G06Q 20/34

(57) ABSTRACT

A system and method of evaluating a network-based transaction between a consumer and a merchant entity. The transaction may be processed to include secret authorization information available to the consumer from a payment authority that manages the consumer's funds. The consumer may obtain the secret authorization information from the payment authority, and the merchant entity may query the consumer for correct secret authorization information before authorizing a transaction. This may enable the merchant to rely at least in part on the payment authority's own authentication methods to authenticate a transaction and substantially avoid fraudulent transactions. The secret authorization information, in one embodiment, may be the amount or amounts in the transaction. The total amount of the transaction may be split into a plurality of random amounts that in sum equal the amount associated with the transaction. The consumer may obtain the random amounts by separately authenticating with the payment authority.

### TECHNICAL FIELD

The present application relates to payment processing over a network, and more particularly to determining authorization for a transaction initiated over a network.

### BACKGROUND

E-commerce and other network based transaction systems have grown with the rise of the Internet. In everyday commerce, entities use network based transaction systems to transfer funds or process payments. Such transfers and processes transpire for a variety of reasons, including, for example, to pay for goods or services and to exchange currency.

In one conventional type of network based transaction, the consumer transfers funds to the merchant in order to pay for goods or services. For instance, the consumer can order a product from the merchant by visiting or utilizing a web-based storefront. It should be understood that the merchant can be any type of business (e.g., an online retailer, bricks and clicks, and brick and mortar), and that selection of a good or service is not limited to a network based selection. Conventionally, after an order has been identified, the consumer pays for the order by providing the merchant with credit card information or information relating to a source of funds. The credit card information along with information relating to an amount of funds to be transferred can be forwarded via a network to a payment gateway, which in turn can communicate an authorization request to a card authority, such as an issuing bank, to obtain authorization for the transfer. The card authority can respond to the request by approving the transaction or declining the transaction. Approval or declination can be communicated to the payment gateway, and in turn to the merchant. This response from the card authority to the merchant is conventionally known as the Authorization or “Auth”. If Authorization for funds indicates approval of a transfer, the merchant fulfils the transaction for the consumer's order. Many merchants accumulate transactions over a period, such as a day, and initiate steps to capture the associated funds from the various card authorities at the end of the period.

It should not go unnoticed that the legitimacy of any particular transaction may be called into question. Fraud or mistakes, or both, can occur at several points along a network-based transaction. For example, the entity or consumer using a credit card may not be authorized to use the credit card. Alternatively, the merchant may submit an incorrect request for an Authorization.

In many cases, because the merchant is the entity requesting the Authorization, the merchant is responsible for incorrect or illegitimate Authorizations and transfers of funds. That is, if a transfer is ultimately considered an unauthorized transfer, the card authority (e.g., the issuing bank) may reverse the transfer. This reversal is often referred to as a “chargeback”, and can be costly to the merchant particularly in circumstances where a fraudulent consumer has already obtained goods or services from the merchant and cannot be subsequently located.

Conventional efforts on several fronts have been made to avoid such chargebacks. One conventional example process includes a merchant preauthorizing use of a consumer card by preemptively transferring different amounts of funds into a consumer's account. The consumer, if authorized by the card authority, can access the account to review these amounts and provide corresponding information to the merchant. If the information provided by the consumer matches the merchants records, the merchant may consider the consumer to be legitimate. This preemptive authorization system is done before any actual transactions can occur, and therefore can cause delays. Further, preauthorization is a one-time process that generally authorizes use of the card on a going forward basis. For at least this reason, the legitimacy of any future transactions can still be in doubt, and result in chargebacks.

### SUMMARY OF THE DESCRIPTION

The present disclosure is directed to a system and method of evaluating a network-based transaction between a first entity and a second entity. In one embodiment, the transaction may be associated with secret authorization information that is unknown to the first entity (e.g., the consumer). The first entity may be required to provide this secret authorization information to the second entity (e.g., the merchant) before the second entity will authorize the transaction. The secret authorization information in one embodiment may be obtained by the first entity only from a payment authority that manages the first entity's funds. If the first entity supplies correct secret authorization information to the second entity, the second entity can proceed with greater confidence that the first entity has authenticated with the payment authority and is authorized to transfer funds from the payment authority. This way, the merchant can rely in part on the payment authority's own authentication processes to authenticate a transaction.

In one embodiment, the secret authorization information may take the form of the amount or amounts associated with the transaction. For instance, the transaction may be broken into a plurality of parts, each including a random amount, to be transmitted as part of an authorization request to an authority. The random amounts may be generated by the second entity, and stored in a database under the control of the second entity. The first entity may obtain one or more of the plurality random amounts by contacting the payment authority. The plurality of random amounts are not communicated directly from the second entity to the first entity. The first entity may authenticate itself with the payment authority to obtain the plurality of random amounts, and provide the random amounts to the second entity. If the plurality of random amounts provided by the first entity correspond to those stored in memory under control of the second entity, the second entity may operate with a degree of assurance that the first entity is authorized with respect to the overall transaction.

In one embodiment, a method of evaluating a network-based transaction between a first entity and a second entity includes obtaining, from the first entity, payment information relating to a source of funds and an amount of funds to be transferred, and randomly determining a plurality of amount values based on the amount of funds to be transferred, where a summation of the plurality of amount values substantially equals the amount of funds to be transferred.

The method according to one embodiment may include transmitting a plurality of authorization requests over a network, the plurality of authorization requests corresponding to the plurality of amount values, and where transmitting includes addressing the plurality of authorization requests to a payment authority associated with the source of funds. Further, the method may include receiving, via the network, an authorization for each of the plurality of authorization requests, where each of the authorizations is generated by the payment authority. The authorization amount information, including authorized values, may be obtained by the first entity from the payment authority. If the authorized values correspond to the plurality of amount values determined randomly and transmitted with the plurality of authorization requests, the first entity may be considered authorized to transfer the amount of funds as part of the transaction.

In another embodiment, the method of evaluating a transaction may include initiating the transaction with the first entity based on input received from the first entity via a networked server, wherein the networked server is controlled at least in part by the second entity, and requesting and receiving a communication address associated with the first entity. The communication address may be usable for communicating information to the first entity, including communicating a unique network address identifier to the first entity that may be accessible by the first entity via the network.

In yet another embodiment, the system may include a merchant server or payment gateway for authenticating a transaction between a merchant and a consumer. The merchant server or payment gateway may include a network interface configured to receive and transmit packets of information over at least one network, and may include a random number generator configured to generate a plurality of random values based on an input value, where a summation of the plurality of random values is substantially equal to the input value.

The merchant server or payment gateway may include a consumer side processor and a merchant side processor. The consumer side processor may be operably coupled to the network interface, and may be in communication with a user interface operable by the consumer to initiate the transaction. The consumer side processor may receive payment information from the user interface for the transaction, where the payment information is indicative of a fund source and a fund amount, wherein the fund amount is provided as the input value to the random number generator to generate the plurality of random values. The merchant side processor may be operably coupled to the network interface, and may be configured to transmit a plurality of authorization requests over the at least one network, where each of the plurality of authorization requests includes at least one of the plurality of random values generated based on the fund amount. The plurality of authorization requests may be addressed to an authorization server associated with the fund source.

The consumer-side processor may be configured to receive authorization amount information obtained from the consumer via the user interface, and to compare the authorization amount information to the plurality of random values transmitted with the authorization requests. A determination about whether the transaction is authorized may be made based on the authorization amount information corresponding to the plurality of random values.

In one aspect, a system and method according to one embodiment of the present disclosure may enable a merchant to achieve an added degree of assurance with respect to a particular transaction between the merchant and a consumer. By generating a plurality of authentication requests, each having a random amount but in total substantially equaling the amount of the transaction, the merchant may prompt the consumer to separately authenticate herself with the payment authority and obtain the random amounts. After determining the values provided by the consumer are correct, the merchant may assume the consumer is authorized for the transaction and fulfill the transaction. In this way, confidence in authorization for individual transactions may be achieved without preauthorizing the consumer in a separate transaction. Further, the random amounts that are authorized against the consumer's source of funds may form part of the transaction, itself, and are not separate therefrom.

These and other advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a system according to one embodiment of the present disclosure.

FIG. 2 show a merchant processor of the system depicted in FIG. 1.

FIG. 3 is a method according to one embodiment of the present disclosure.

FIG. 4 is a method according to one embodiment of the present disclosure.

### DESCRIPTION

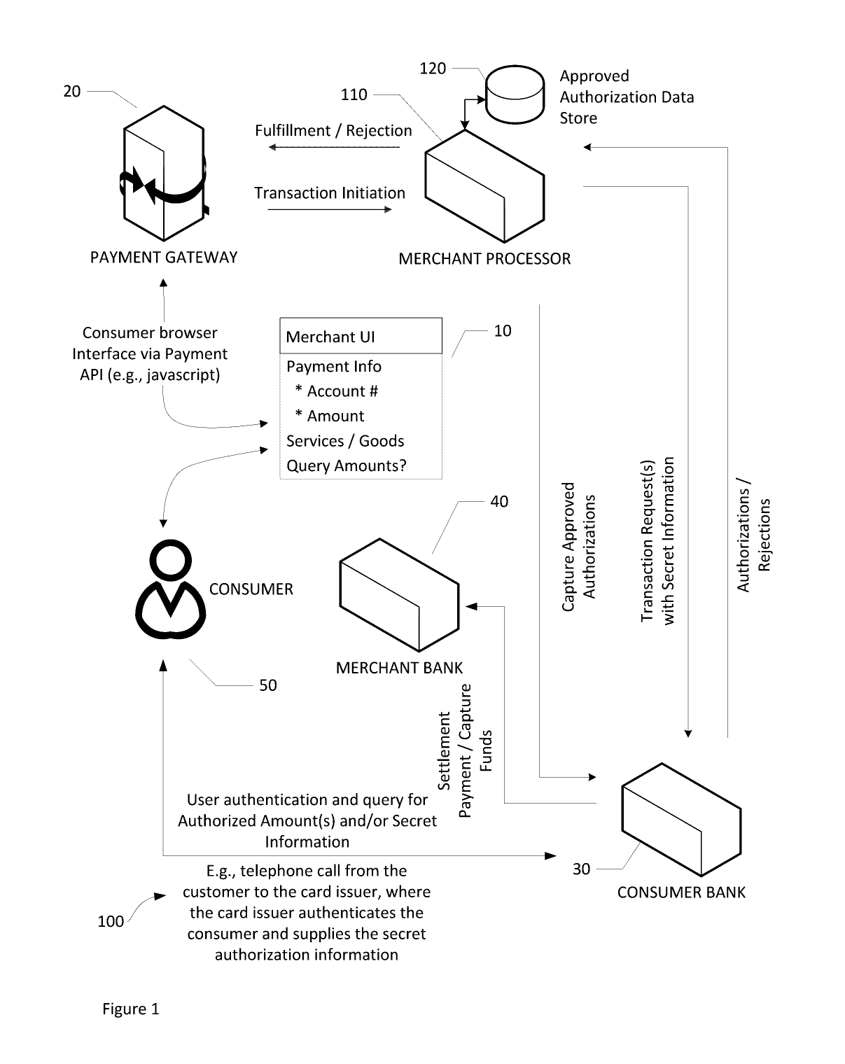

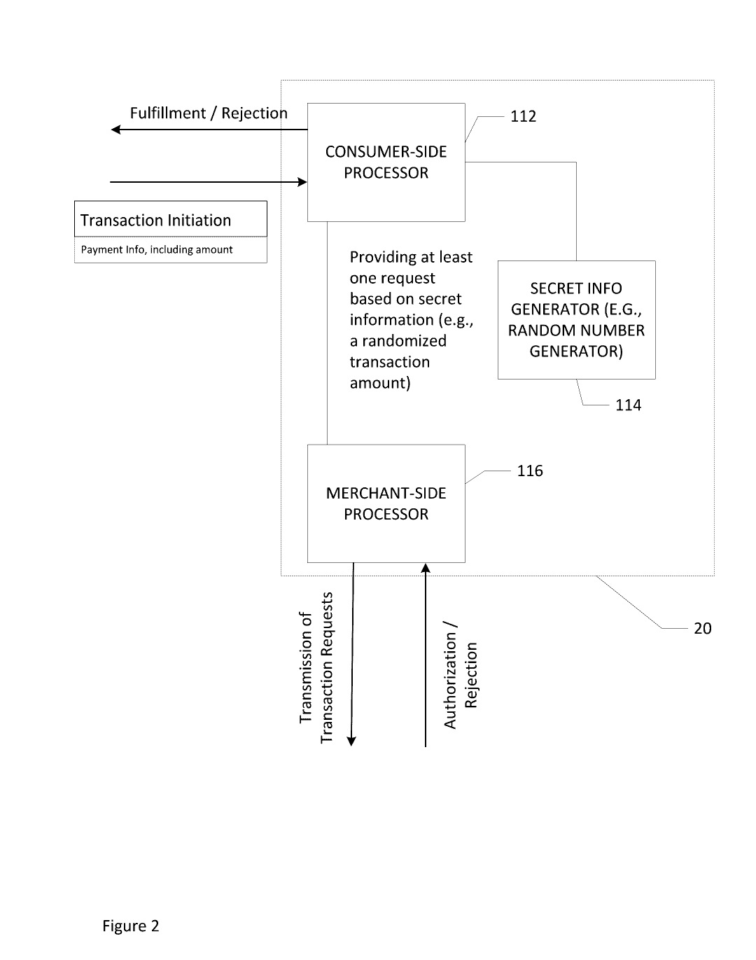

A network-based transaction system for transferring funds from one entity to another is shown in FIGS. 1-2, and is generally designated 100. The network-based transaction system may include a merchant user interface 10, a merchant processor 110, a payment gateway 20, a payment authority 30, a merchant bank 40, and consumer 50. As mentioned herein, the entity transferring funds is often referred to as a “consumer”, and the entity receiving funds is referred to as a “merchant”. These names are a helpful expedient for understanding the flow of a transaction, and in many cases the entities are related according to their namesake. However, it should be understood that the present disclosure is not so limited, and that the consumer and merchant in any transaction may not be related as merchant/consumer in a conventional sense of exchanging goods for payment. For example, a transfer of funds from a consumer to a merchant may simply be initiated to transfer funds to the merchant for nothing in exchange. To provide some additional examples, the merchant may be a currency exchange that exchanges one type of currency for another (e.g., U.S. dollars in exchange for bitcoins), or an intermediary for transferring funds from one entity to another.

In the illustrated embodiment, the consumer 50 may utilize the merchant user interface 10 to communicate with the merchant processor 110 or a payment gateway 20, or both. The merchant user interface 10 may allow communication regarding a transaction. For example, the merchant user interface 10 may allow the consumer 50 to initiate a transaction. Additionally, or alternatively, the merchant user interface 10 may enable communication to and from the merchant processor 110 or the payment gateway 20, or both, regarding a state of a transaction or information related to the transaction, or a combination thereof.

In one embodiment, the merchant user interface 10 may be provided to a web browser being operated by the consumer 50. Communication between a) the merchant processor 110 or the payment gateway 20, or both, and b) the merchant user interface 10 being rendered by the web browser may be a secure channel or an encrypted link, such as a secure socket layer connection between the user interface 10 and the merchant processor 110 or the payment gateway 20, or both.

The merchant user interface 10 according to one embodiment may be preinstalled as an interface module on a user device. Additionally, or alternatively, the interface module can be communicated to the user device via the network by the merchant processor 110 or another device, such as another merchant controlled processor. It should be understood that there can be one or more than one user device in the system, and that one device can obtain the merchant module in a manner different from another user device.

The merchant user interface 10 in one embodiment may generate a storefront that enables the consumer 50 to select one or more goods or one or more services, or a combination thereof. As an example, the storefront provided and generated by the merchant user interface 10 may include several options for different amounts of digital currency, such as bitcoins. The consumer 50 may select one of these options to initiate a transaction to purchase a specific amount of digital currency. Successful fulfillment of a digital currency transaction may include communicating, from the merchant processor 110, at least one of a private key associated with a digital currency address and a transaction request to transfer digital currency to an existing digital currency address controlled by the consumer 50.

It should be understood that the storefront provided by the merchant user interface 10 may be used to conduct any type of transaction or any step of a transaction, or a combination thereof, including initiating a transaction and communicating information related to a transaction.

Further, although described in connection with a user interface provided via a principal communication channel—that is, between a merchant processor 110 or payment gateway 20, or both, and a web-enabled application operated by the consumer 50—it should be understood that one or more steps in a transaction, including initiation of the transaction, may be conducted by a distributed user interface through separate communication channels. For instance, the consumer 50 may initiate a transaction by visiting a merchant's storefront, provided by one communication channel, and make a selection of goods or services. After the transaction is initiated, the consumer 50 may be provided a network address or Uniform Resource Locator (URL) that, in one or more embodiments, is unique to the transaction. After establishing another communication connection to the URL, the consumer 50 may proceed through additional steps related to the transaction, including, for example, entry of payment information related to a source and amount of funds. In one embodiment, the URL may be specific to a transaction, and may be persistent with respect to the transaction. In other words, the URL may redirect the consumer 50 to the current state of the process for the transaction, and may be valid throughout the transaction and optionally after the transaction has been completed. More specifically, in one embodiment, the URL may remain a valid, persistent session key for the life of the transaction. The state of the information provided via the URL may be available for the life of the transaction, and in one embodiment, after the transaction has completed. The consumer 50 may leave or disconnect from the communication connection via the URL, and return at a later time to continue or check the status of the transaction. For example, if the consumer 50 disconnects from their network connection or experiences an interruption, the consumer 50 can return to the transaction via the URL. As another example, the consumer 50 may leave the connection to the URL to contact the payment authority 30 (e.g., their card issuer) to obtain the authorized amounts, and then return at a later time to provide the authorized amounts.

In one embodiment, the persistent session key or URL may lead to communication with an entity other than the merchant or merchant user interface 10. As an example, the payment gateway 20 may be configured to generate the persistent session key or URL, and to provide the persistent session key to the consumer 50 via one or more communication paths (e.g. through the merchant user interface 10 or to a communication address associated with the consumer 50). In using the persistent session key, the payment gateway 20 may wait for the consumer 50 to provide, via a communication session established with the persistent session key, authorization information corresponding to secret information generated by the payment gateway 20 (e.g., one or more of a plurality of random amounts corresponding to those generated by the random number generator) and sent to the consumer bank 30. After the consumer 50 has provided authorization information corresponding to the secret information (e.g., the correct amounts), the payment gateway 20 may initiate steps to authorize the transaction and communicate such authorization to the merchant.

Use of the persistent session key or URL to access status information with respect to the transaction and to enable entry of the authorized amounts may not require authentication for re-entry. For instance, after the persistent session key is provided via SMS text or email during the initial stages of the transaction, the consumer 50 may not be required to authenticate to utilize the persistent session key. As mentioned herein, the persistent session key may be sufficiently unique and brief for ease of typing to facilitate use by the consumer 50. It should be noted that the persistent session key, itself, does not correlate or have any correspondence with the random amounts generated by the random number generator and associated with the transaction. According to one embodiment, the consumer 50 may obtain the authorized amounts corresponding to the random amounts from their card authority, and provide those authorized amounts via a communication session established via the persistent session key.

In one embodiment, after a consumer 50 has initiated a transaction, the merchant user interface 10 may prompt for entry of a communication address that is usable for communicating information to the consumer 50. To provide some examples, the communication address may be a cellular phone number to which a short message service (SMS) text can be transmitted, or the communication address may be an email address associated with the consumer 50. Using the communication address associated with the consumer 50, the system 100 may communicate the URL or the network address that is specific to the transaction in accordance with one embodiment of the present disclosure. As mentioned herein, the consumer 50 may utilize the URL or network address to proceed through one or more steps of the transaction.

One or more embodiments according to the present disclosure—though described in conjunction with use of a web-enabled application—are not limited to such a configuration. For instance, the merchant user interface 10 may be generated by any type of application interface, including application-specific interface being operated by the consumer 50. As another example, the merchant user interface 10 may be generated by a stand-alone device, such as a credit card terminal, that is physically present within a store.

It should also be understood that—although steps of a transaction are described in connection with a user interface over a network or online—initiation of the transaction may be conducted offline, such as face to face. For instance, initiation of a transaction may occur in a brick and mortar place of business in which the consumer 50 chooses one or more goods to purchase, and proceeds to check out at a counter.

In the illustrated embodiment, after a transaction has been initiated, the consumer 50 may be prompted to provide information related to a source of funds to the merchant user interface 10. The consumer 50 may also be prompted to provide information relating to an amount of funds to be transferred from the source. However, in some embodiments, the amount of funds may be calculated and displayed by the merchant user interface 10 such that entry of the amount of funds by the consumer 50 is unnecessary. Prompting for information may be achieved in a variety of ways. For example, the merchant user interface 10 may prompt the consumer 54 for information by displaying one or more blank entry fields along with labels corresponding to information to be entered by the consumer 50 into the blank entry fields.

After the merchant user interface 10 has received information related to a source of funds, the merchant user interface 10 may facilitate communication of a transaction request for processing by the merchant processor 110. In one embodiment, the information may include credit card information, including a credit card number, a type of credit card, name, billing address, card expiration date, and card verification value, or a subset thereof. The merchant user interface 10 may be a website served to the consumer via a network by the merchant processor 110 or another merchant controlled processor or server. The merchant user interface 10 may include a server-side or client-side hosted interface to the payment gateway 20 to facilitate generation of the transaction request and transfer of funds. As an example, the payment gateway 20 may be associated with an Application Programming Interface (API) that may be utilized by the merchant user interface 10 to communicate with the payment gateway 20. The API may be implemented or utilized in a variety of ways, including, for example, JavaScript, Active Server Pages (ASP) or another scripting language. In some configurations, the user's browser may communicate with the payment gateway 20 via the API in order to generate a transaction request to transfer funds.

In the illustrated embodiment of FIG. 2, the payment gateway 20 may include a consumer-side processor 112, a merchant-side processor 116 and a secret information generator 114 (e.g., a random number generator). One or more components of the payment gateway 20 may be integrated into a merchant server, or may be located in one or more separate servers capable of communicating with each other. Further, in one embodiment, one or more components of the payment gateway 20 may be integrated into a single processor. For instance, the consumer-side processor 112, the secret information generator 114 and the merchant-side processor may all be integrated into a payment processor configured to carry out processes of the respective components.

The payment gateway 20 may be a server configured to execute one or more modules with processes associated with the consumer-side processor 112 and the merchant-side processor 116. The term module should be understood to mean any and all software associated with providing the modules function. For example, each module can include code for processing information, displaying information to the consumer 50 or accepting input from a consumer 50. The module can include code written in HTML, Flash, Java, or any other computer programming language in order to provide the functionality for that particular module. The code for a particular module may not be exclusive to that module and can be used in multiple modules.

The consumer-side processor 112 in the illustrated embodiment may receive information related to a transaction, such as a source of funds and an amount of funds. The consumer-side processor 112 may communicate the amount of funds to the secret information generator 114, which may generate secret authorization information unknown to the consumer but incorporated into the transaction request communicated to the source of funds or consumer bank 30 associated with the source of funds. The payment gateway 20 may communicate the transaction request to the merchant processor 110, which, in turn, may communicate the transaction request to the consumer bank 30. The secret authorization information may be obtained by the consumer 50 and provided to the payment gateway 20 via the merchant user interface 10. In this way, the payment gateway 20 may rely in part on the payment authority 30 to authenticate that the consumer 50 is authorized to transfer funds associated with the account identified by the consumer 50. The secret authorization information may take many forms, such as secret text provided in the comment or memo section of the transaction request or the amount of funds identified in the transaction request, or a combination thereof. In one embodiment in which the amount of funds is split into multiple transactions of possibly random amounts, the payment gateway 20 may authenticate a transaction based on the consumer's input of one or more of the amounts. In one embodiment, the secret authorization information may take the form of a randomly split sub amount associated with the transaction. In one embodiment, the secret authorization information may be bifurcated or spread among a plurality of transactions, such as by generating secret text that is sliced into sections that are respectively associated with each of the plurality of transactions.

In one embodiment the secret information generator 114 may generate a plurality of random amounts that in total sum to the amount of funds identified by the consumer 50 to the consumer-side processor 112. The plurality of random amounts generated by the secret information generator 114 may be communicated to the merchant-side processor 116. In one embodiment, the random amounts, the summation of which substantially equals the total amount of funds identified using the merchant user interface 10, may be determined according to one or more predefined rules or criteria. For example, the random amounts may be determined such that each random amount is greater than a minimum value, such as 10, 5, or 1.

The secret information generator 114 may be a random number generator based on any type of hardware module or any type of software module, or a combination thereof, that is capable of generating one or more random numbers to be used in conjunction with generating the plurality of random amounts that in sum total to the amount of funds identified to the consumer-side processor 112. It should be understood that the randomness of a random number or its degree of entropy can vary among different types of random number generators. In some random number generators, often when computational algorithms or deterministic components are utilized to produce the random number, the random number output is considered a pseudorandom number. The pseudorandom nature of such generators can be substantially reduced or avoided through use of computational techniques (e.g., entropy pooling), yielding a random number generator that for many purposes can be considered substantially truly random. Entropy pooling according to one embodiment may utilize a plurality of entropy sources in conjunction with each other so that together the sources exhibit a high degree of entropy that may not otherwise be present in each of the sources, individually.

Other random number generators can utilize noise in physical phenomena or natural entropy to generate what is considered a truly random number. However, it should be understood that, in some random number generator configurations, a random number based on measured noise in physical phenomena may still not be truly random because the components used to measure the noise can introduce bias. On the other hand, a random number generator may be configured to substantially avoid such measurement bias, and therefore generate a truly random number.

The random number generator in one embodiment may be configured to generate one or more random numbers having a high degree of entropy. In other words, the one or more random numbers may be sufficiently random such that attempts to compromise the random number generator or to guess a random number from the random number generator are not computationally practical. The random number generator in one configuration may generate one or more random numbers that are or approach being impossible to guess. In one embodiment, the random number generator 114 may include a hardware-based random number generator, such as a hardware implementation or hardware assisted random number implementation, that generates one or more random numbers that are substantially truly random. One example of such a random number generator is based in part on natural entropy that has a substantially low degree of measurement bias. The random number generator may utilize a seed or salt based on the substantially truly random number for generating a plurality of random numbers.

In one embodiment, the random number generator may randomly divide the amount received from the consumer-side processor 112 into two random amounts. The two random amounts may be determined by generating a random value within a range of potential values, and multiplying each amount by a factor that is a function of the random value and the maximum range of random values. The random number generator may be configured to ensure that summation of the plurality of random amounts substantially equals the amount received from a consumer-side processor 112, and to ensure that each of the random amounts is greater than a minimum threshold, as mentioned herein. To provide an example, the amount received from the consumer-side processor may be 12345, and the random value generated for this amount may be 0.6789 within a range of 0 to 1. The random amounts in this example may be calculated as 8381 and 3964, which in total equal 12345.

The consumer-side processor 112 may generate an information packet based on the source of funds and the secret authorization information (e.g., one or more of the random amounts provided by the random number generator). Alternatively, the consumer-side processor 112 may generate a separate information packet for each of the plurality of random amounts generated by the random number generator, where each information packet includes the source of funds and a respective random amount. Each information packet may also include a transaction identifier that enables association between the information packet and the transaction.

In one embodiment, the consumer-side processor 112 may selectively determine based on one or more criterion whether to generate a plurality of random amounts to be transmitted to the merchant processor 110. For instance, if a transaction is determined to be a low-fraud risk, the consumer-side processor 112 may bypass generation of random amounts, and transmit the amount of the transaction to the merchant-side processor 116. On the other hand, if the transaction is determined to be a high-fraud risk, the consumer-side processor 112 may transmit the plurality of random amounts according to one embodiment of present disclosure. It should be understood that the present disclosure is not limited to a determination of fraud risk—any type of criteria may be used to determine whether to generate a plurality of random amounts. As an example, the merchant may decide that a particular good or service should be associated with a heightened level of authentication, and therefore the payment gateway 20 may be configured accordingly to generate a plurality of random amounts, initially unknown to the consumer 50, for transactions associated with that particular good or service. The payment gateway 20 may include a database of criteria used to determine which type of processing to utilize for each transaction.

Using the information packet or packets received from the consumer-side processor 112, the merchant-side processor 116 may generate a transaction request including or based on the secret authorization information. In configurations in which a plurality of random amounts are generated, the merchant-side processor 116 may generate a transaction for each of the plurality of random amounts, and transmit the plurality of transaction requests to the merchant processor 110. Alternatively or additionally, a single transaction request may include a plurality of the random amounts.

The merchant processor 110 may receive the one or more transaction requests, and generate an Authorization Request that is addressed to and ultimately received by the payment authority 30 associated with the source of funds. Before communicating the Authorization Request, the merchant processor 110 may conduct one or more tests on the transaction to determine the likelihood that the transaction is authorized. For example, the merchant processor 110 may determine whether the location associated with the merchant user interface 10 is consistent with a location of an authorized user associated with the source of funds. If the merchant processor 110 determines the transaction is likely not authorized, the merchant processor 110 may respond to the payment gateway 20 with a rejection of the transaction request. Alternatively, or additionally, the payment gateway 20 may conduct one or more tests on the transaction to determine the likelihood that the transaction is authorized.

If the merchant processor 110 determines the transaction is likely authorized, the Authorization Request may be generated for submission to a payment authority 30. The Authorization Request may include an address associated with the payment authority, and may be communicated to the payment authority 30 via the one or more networks or one or more subnetworks, or a combination thereof. For example, the Authorization Request may be communicated by the merchant processor 110 to a network specifically associated with and utilized by the type of credit card being used, and ultimately transmitted to the payment authority 30. As another example, the Authorization Request may be routed through the Internet to the payment authority 30 via a secure communication tunnel or subnetwork established on the Internet.

Assuming the merchant processor 110 will ultimately determine the one or more transaction requests associated with a particular transaction are authorized, the merchant processor 110 may communicate an Authorization Request for each transaction request received from the payment gateway 20. In one embodiment, each of the plurality of Authorization Requests may include a request for authorization with respect to one of the plurality of random amounts generated by the payment gateway 20. The total sum of the amounts requested in the Authorization Requests may equal the total amount related to the transaction. Because the random amounts are generated by the payment gateway 20, neither the merchant processor 110 nor the payment authority 30 may be aware as to actual total amount associated with the transaction. Conversely, because the payment gateway 20 may determine the plurality of random values separate from the consumer 50 and the merchant user interface 10, and generate a transaction request for each random value, the consumer 50 may be unaware as to the amounts included in the Authorization Requests transmitted to the payment authority 30. Likewise, with respect to other forms of secret authorization information (e.g., secret text identified in the transaction request), the consumer 50 may be unaware of the secret authorization information unless the consumer 50 obtains the secret authorization information from the payment authority 30.

The payment authority 30 may process the one or more Authorization Requests, and respond with an Authorization or “Auth” or a rejection. In many cases, whether the response is authorized depends on the amount of funds available being sufficient to cover the amount being requested. That is, the payment authority 30 may compare the amount included in the Authorization Request to the amount of funds associated with the respective source of funds, and communicate an Authorization if there are sufficient funds to cover the amount in the Authorization Request. If there are insufficient funds, the payment authority 30 may communicate a rejection to the merchant processor 110, which in turn may be communicated to the payment gateway 20 and possibly to the merchant user interface 10.

Along with communicating an Authorization, the payment authority 30 may create an entry in a database associated with the Authorization and its authorized amount. This may function as a hold on the funds in the source or account of the consumer 50. The Authorization communicated by the payment authority 30 may include an authorization identifier that identifies the Authorization to the payment authority 30 and stored with the entry in the database. In this way, the authorization identifier may be utilized by the payment authority 30 and the merchant processor 110 for settlement of funds. Settlement may include transferring funds from the source of funds managed by the payment authority 30 to a merchant fund repository 40 or a merchant account managed by a bank.

The merchant processor 110 may receive the Authorization via the one or more networks similar to the manner in which the Authorization Requests and the transaction requests are communicated, as discussed herein. The Authorizations may be stored in a merchant database 120 and associated with the overall transaction initiated by the consumer 50. Although the payment gateway 20 may have conducted some analysis of the transaction requests to determine authorization, in many cases, the merchant is held responsible for fulfilling an unauthorized transaction, and is subject to a chargeback initiated by the payment authority 30. That is, if the merchant fulfills a transaction or transfers goods or services to the consumer 50 in exchange for funds, but the transaction turns out to be unauthorized, the payment authority 30 may initiate a chargeback to return the transferred funds to the source being managed by the payment authority 30. Such a chargeback request may be communicated via one or more networks in a manner similar to the Authorization and Authorization Requests described herein.

In the illustrated embodiment, the merchant user interface 10 may prompt or inform the consumer 50 to contact the payment authority 30 or another entity having access to the database that stores information related to the source of funds owned by the consumer 50. Because the merchant does not inform the consumer 50 of the secret authorization information (e.g., the plurality of random amounts) included in the Authorization Requests and associated with the Authorizations, consumer 50 may obtain the secret authorization information (e.g., values of the random amounts) by other means, such as by proceeding through a separate authentication process between the consumer 50 and the payment authority 30. For example, the consumer 50 may login to a website managed by the payment authority 30 in order to access information relating to the source of funds, including holds on the fund source like the one or more amounts associated with the one or more Authorizations. As another example, the consumer may call the payment authority 30 to obtain the secret authorization information associated with the one or more Authorizations. Because the consumer 50 may not be initially aware of the secret authorization information, such as the random amounts that have been authorized, in connection with the transaction, the merchant may increase its degree of confidence with respect to the transaction by requiring the consumer 50 to authenticate directly with the payment authority 30 to obtain the secret authorization information. In yet another example, the consumer 50 may obtain the secret authorization information via a smartphone application provided by the payment authority 30.

After the consumer 50 obtains the secret authorization information from the payment authority 30, the secret authorization information (e.g., one or more random amounts associated with a plurality of random amounts, or secret text provided in the transaction request, or a combination thereof) may be submitted by the consumer 50 to the merchant user interface 10 and communicated to the payment gateway 20. In one embodiment in which the secret authorization information takes the form of a plurality of random amounts, the payment gateway 20 may retrieve, based on the transaction identifier, the Authorized amounts or secret authorization information stored in memory and associated with the transaction and compare the authorized amounts to the amounts submitted by the consumer 50. If the secret authorization information or submitted amounts correspond to the secret authorization information or authorized amounts stored in memory, the payment gateway 20 may fulfill the transaction with confidence in the transaction being truthfully authorized that would otherwise not be present in a conventional transaction.

One embodiment of the present disclosure may involve determining a transaction is authorized at least in part based on the secret authorization information provided by the consumer corresponding to the secret authorization information incorporated into or forming the basis for a transaction request communicated to the payment authority. If the consumer provides information that is incorrect or does not correspond to the secret authorization information, the system may take steps to void or reverse the transaction. For instance, if the merchant-processor has received authorization for a transaction and the transaction is ultimately considered unauthorized, rather than trying to settle the approved authorization to initiate transfer of funds, the merchant-processor may initiate a reversal of charges or take steps to void the transaction request and avoid transfer of funds. In one embodiment, the payment gateway may take steps to void or reverse the transaction if no information is provided by the consumer after a period of time, which may be predetermined or may be variable based on a variety of factors (including perceived level of risk associated with a transaction). This way, if the consumer does not obtain the secret authorization information from the payment authority, and allows the transaction to become stale, the system may determine the transaction is unauthorized to avoid transfer of funds.

In embodiments that generate a plurality of transactions with random amounts, it should not go unnoticed that by breaking the transaction into several random amounts, initially blind to the consumer, authorization of individual transactions may be based on assurance that the payment authority 30 has separately authenticated the consumer 50 and provided the authorized amount information to the consumer 50. The transaction, itself, may be considered authorized based on reception of correct amount information from the consumer 50. No preapproval or preauthorization process may be implemented or utilized to achieve the degree of confidence obtained by the system 100 according to the illustrated embodiment. Likewise, with respect to the consumer 50 obtaining any secret authorization information, because this information is obtained from the payment authority 30 and kept secret from the consumer 50 in the merchant user interface 10, the payment gateway 20 can rely in part on the authentication process of the payment authority 30 to authenticate the transaction.

As discussed herein, the system 100 may utilize a unique URL to provide the consumer 50 with a portal for information related to the transaction. After the merchant processor 110 determines the consumer 50 has correctly identified the secret authorization information (e.g., the random amounts) associated with the one or more Authorizations, the merchant processor 110 may process the one or more transactions for settlement from the source of funds to a merchant fund repository, and may fulfill the transaction. In one embodiment, the merchant user interface 110 available at the URL may remain valid, show order status of the transaction, and provide a receipt. Links or other contact information relating to consumer service for the merchant and initiation of additional transactions may also be available via the merchant user interface 110.

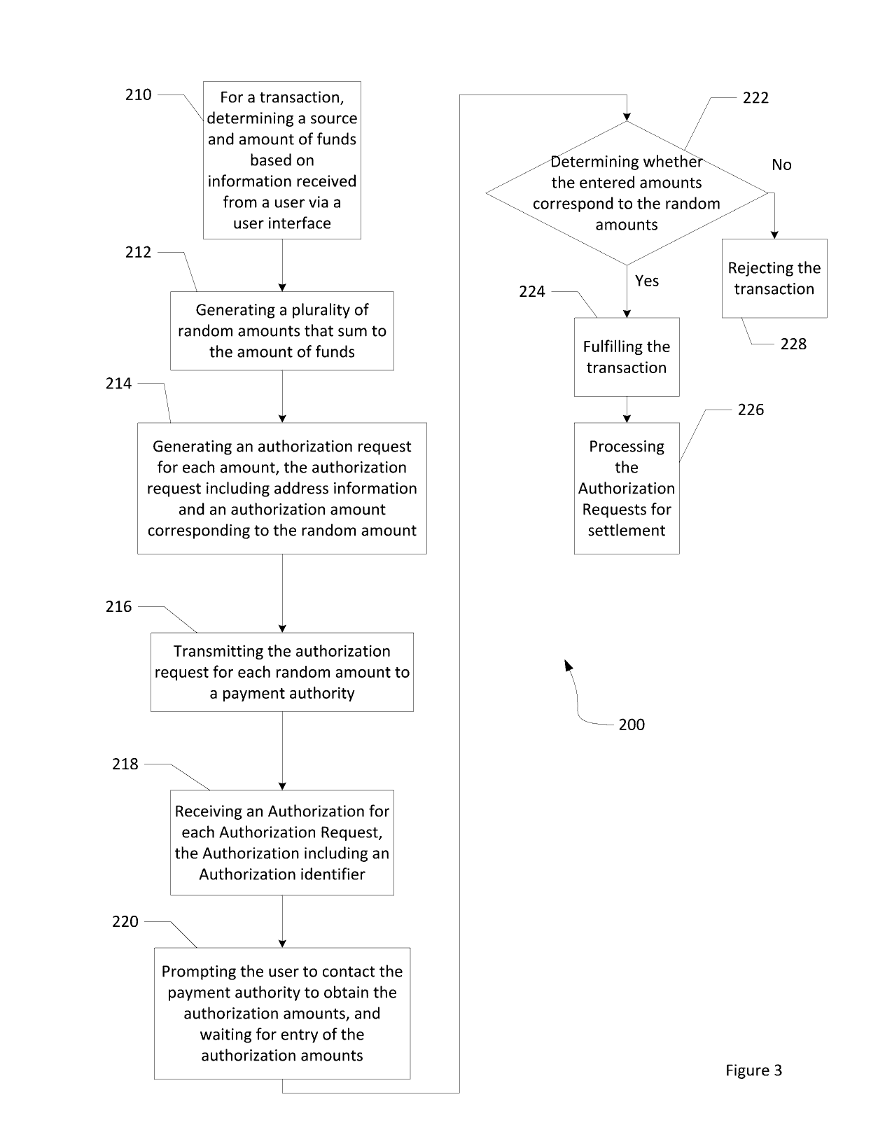

A method according to one embodiment of the present disclosure is depicted in FIG. 3, and generally designated 200. The method may be conducted by a system similar to the system 100 described in connection with the illustrated embodiments of FIGS. 1-2. For example, one or more steps of the method may be conducted by a payment gateway or transaction processor configured to interface with one or more networks that enable communication with a merchant user interface and a merchant processor, and ultimately with a payment authority.

The method may include the step of determining a source and an amount of funds based on information received from a user interface. Step 210. Based on the amount for the transaction, a plurality of random amounts may be generated that together substantially equal the base amount. The transaction processor may generate a transaction request for each random amount, and initiate communication of the transaction requests to a payment authority via a network. The transaction requests may include address information relating to the source of funds to aid in routing the transaction requests to the payment authority. Step 214. In one embodiment, the transaction requests may be communicated to a merchant processor that generates a plurality of authorization requests corresponding to the plurality of transaction requests. The authorization requests may be communicated to the payment authority via a network. Step 216.

Upon receipt of the plurality of authorization requests, the payment authority may communicate an authorization or a communication packet indicating the transaction processor is authorized to settle and effect transfer of the amount of funds from the source to a repository owned by the merchant. Step 218. The transaction processor may prompt the consumer to contact the payment authority to obtain the amounts authorized by the payment authority. For instance, the consumer may directly authenticate with the payment authority to obtain the amounts authorized. Direct authentication may be conducted by calling the payment authority or logging into a web server under control of the payment authority. The consumer may authenticate with the payment authority, obtain the authorized amounts, and communicate the amounts to the transaction processor via the user interface.

The transaction processor may compare the amounts received from the consumer to the authorized amounts stored in memory, and determine the transaction is authorized in response to these amounts being the same. An authorized transaction may be fulfilled and ultimately settled for transfer of funds. Steps 222, 224, 226. If the amounts are different, the transaction may be considered unauthorized and rejected.

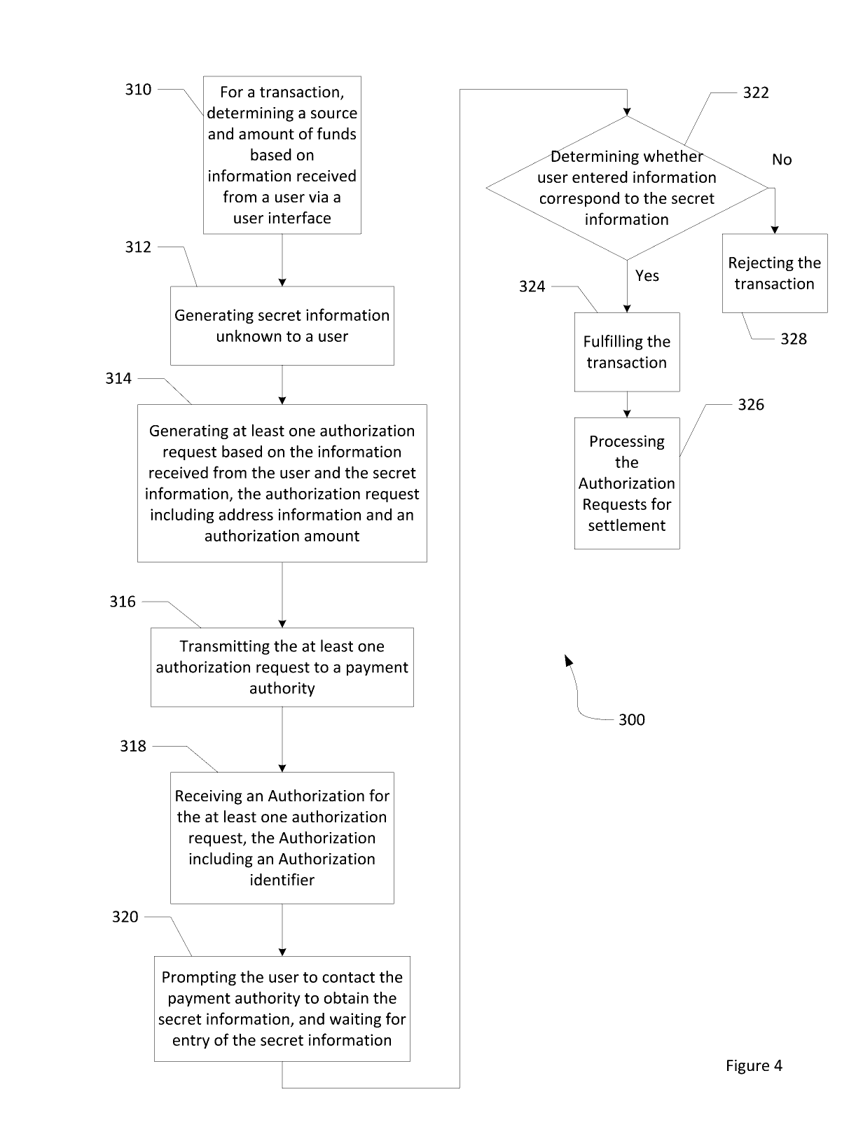

A method according to one embodiment of the present disclosure is depicted in FIG. 4, and generally designated 300. The method may be conducted by a system similar to the system 100 described in connection with the illustrated embodiments of FIGS. 1-2. For example, one or more steps of the method may be conducted by a payment gateway or transaction processor configured to interface with one or more networks that enable communication with a merchant user interface and a merchant processor, and ultimately with a payment authority.

The method may include the step of determining a source and an amount of funds based on information received from a user interface. Step 310. Secret information may be generated based on the information received from the user interface. The secret information may include one or more amounts associated with the transaction, or secret text to be included in a comment or memo section of the transaction. The secret information in one embodiment may be based on a one-way hash (e.g., SHA-2 or Secure Hash Algorithm 2) of the all or part of the information received from the user interface. The transaction processor may generate one or more transaction requests that include or are based on the secret information, and initiate communication of the one or more transaction requests to a payment authority via a network. The one or more transaction requests may include address information relating to the source of funds to aid in routing the one or more transaction requests to the payment authority. Step 314. In one embodiment, the one or more transaction requests may be communicated to a merchant processor that generates one or more authorization requests corresponding to the one or more transaction requests. The authorization requests may be communicated to the payment authority via a network. Step 316.

Upon receipt of the one or more authorization requests, the payment authority may communicate an authorization or a communication packet indicating the transaction processor is authorized to settle and effect transfer of the amount of funds from the source to a repository owned by the merchant. Step 318. The transaction processor may prompt the consumer to contact the payment authority to obtain the secret authorization information from the payment authority. For instance, the consumer may directly authenticate with the payment authority to obtain the secret authorization information. Direct authentication may be conducted by calling the payment authority or logging into a web server under control of the payment authority. The consumer may authenticate with the payment authority, obtain the secret authorization information, and communicate the secret authorization information to the transaction processor via the user interface.

The transaction processor may compare the consumer provided authorization information against the secret authorization information stored in memory, and determine the transaction is authorized in response to the consumer provided authorization information being consistent with the secret authorization information stored in memory. An authorized transaction may be fulfilled and ultimately settled for transfer of funds. Steps 322, 324, 326. If the consumer provided authorization information is not consistent with the secret authorization information stored in memory, the transaction may be considered unauthorized and rejected.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of evaluating a network-based transaction between a first entity and a second entity, the method comprising:
obtaining, from the first entity, payment information relating to a source of funds and an amount of funds to be transferred to the second entity;
generating secret authorization information that is unknown to the first entity;
generating, based on the payment information, at least one authorization request to be communicated over a network, wherein the authorization request includes the secret authorization information unknown to the first entity;
transmitting the at least one authorization request, said transmitting including addressing the at least one authorization request to a payment authority associated with the source of funds;
receiving an authorization response from the payment authority for the at least one authorization request;
obtaining entity authorization information from the first entity, wherein the entity authorization information is provided to the first entity by the payment authority; and
determining the first entity is authorized to transfer the amount of funds based on the entity authorization information corresponding to the secret authorization information.

2. The method of claim 1 wherein said generating the secret authorization information includes randomly determining an amount value based on the amount of funds to be transferred.

3. The method of claim 2 wherein said generating the secret authorization information includes randomly determining a plurality of amount values based on the amount of funds to be transferred; and
wherein said generating the at least one authorization request includes generating a plurality of authorization requests for respective authorized values corresponding to the plurality of amount values determined randomly.

4. The method of claim 3 wherein said transmitting includes transmitting the plurality of authorization requests over a network, wherein the plurality of authorization requests corresponds to the plurality of amount values, wherein a summation of the plurality of amount values substantially equals the amount of funds to be transferred;
wherein said obtaining entity authorization information includes obtaining from the first entity at least one entity obtained amount value associated with the plurality of authorization requests; and
wherein said determining includes determining the first entity is authorized to transfer the amount of funds based on the at least one entity obtained amount value corresponding to at least one of the amount values.

5. The method of claim 4 wherein the at least one entity obtained value includes a plurality of entity obtained values corresponding in number to a number of the plurality of authorization requests; and
wherein said determining includes determining the first entity is authorized to transfer the amount of funds based on the plurality of entity obtained amount values corresponding to the plurality of amount values.

6. The method of claim 1 wherein the secret authorization information included in the at least one authorization request is unique data based on the payment information.

7. The method of claim 1 further comprising:
initiating a transaction with the first entity based on input received from the first entity via a networked server, wherein the networked server is controlled at least in part by a second entity;
requesting and receiving a communication address associated with the first entity, wherein the communication address is usable for communicating information to the first entity; and
transmitting a unique network address identifier that is accessible by the first entity via the network.

8. The method of claim 7 wherein the unique network address identifier enables the first entity to access a current step in a network-based transaction, and wherein the unique network address identifier is valid for the life of the network-based transaction

9. The method of claim 1 wherein the payment information provided by the first entity includes payment card details associated with a card issued by a bank, wherein the first entity has authority over an account that is managed by the bank and paired with the card, and wherein the account is the source of funds.

10. The method of claim 4 wherein the plurality of amount values determined randomly include a first value and a second value that add up to the amount of funds to be transferred to the second entity from the first entity, the first value and the second value being randomly selected and greater than a minimum value.

11. The method of claim 5 further comprising instructing the first entity to contact the payment authority to obtain the plurality of authorized values for which the payment authorized has granted approval.

12. A payment gateway for facilitating a transaction between a merchant and a consumer, said payment gateway including:
a network interface configured to receive and transmit packets of information over at least one network;
a secret information generator configured to generate, based on an input, secret authorization information unknown to the consumer;
a consumer side processor operably coupled to said network interface, said consumer side processor being in communication with a user interface operable by the consumer to initiate the transaction, said consumer side processor configured to receive payment information from the user interface for the transaction, wherein said payment information is indicative of a fund source and a fund amount, wherein said payment information is provided as said input value to said secret information generator;
a merchant side processor operably coupled to said network interface, said merchant side processor configured to transmit at least one transaction request over the at least one network, said at least one transaction request including said secret authorization information, wherein said at least one transaction request is addressed to an authorization server associated with the fund source; and
said consumer side processor configured to receive consumer authorization information obtained from the consumer via the user interface, said consumer side processor configured to determine the transaction is authorized based on said consumer authorization information corresponding to said secret authorization information.

13. The payment gateway of claim 12 wherein said secret information generator is a random number generator configured to generate a plurality of random values based on the fund amount, a summation of said plurality of random values being substantially equal to the fund amount;
wherein said merchant side processor is configured to transmit a plurality of transaction requests including at least one of said plurality of random values; and
wherein said consumer side processor determines the transaction is authorized based on said consumer authorization information corresponding to one or more of said plurality of random values.

14. The payment gateway of claim 13 wherein the random number generator is a hardware-based random number generator configured to generate a substantially truly random number, wherein said hardware-based random number generator utilizes an entropy pool as a basis for generating said substantially truly random number.

15. The payment gateway of claim 12 wherein said consumer side processor is configured to communicate a network accessible communication address to the consumer, said network accessible communication address being associated with a user interface processor that provides the user interface to the consumer.

16. The payment gateway of claim 15 wherein said consumer side processor is configured to instruct the consumer to obtain said consumer authorization information, wherein prior to obtaining said consumer authorization information, said secret authorization information is unknown to the consumer.

17. The payment gateway of claim 15 wherein said consumer side processor is configured to:
receive, from the consumer, a communication address that is usable for communicating information to the consumer;
generate a unique network accessible communication address for accessing a status of the transaction;
communicate said unique network accessible communication address to the consumer based on the communication address provided by the consumer.

18. The payment gateway of claim 17 wherein said unique network accessible communication address is unique to the transaction.

19. The payment gateway of claim 12 wherein said payment information includes payment card details associated with a card issued by a bank, wherein the consumer has authority over an account that is managed by the bank and paired with the card, wherein the account is the source of funds.

20. A transaction authorization system for individually authorizing a transaction between a consumer and a merchant, said transaction authorization system comprising:
a secret information generator configured to generate secret authorization information unknown to the consumer;
a transaction processor operably coupled to a network interface, said transaction processor being in communication with a user interface operable by the consumer to initiate the transaction, said transaction processor configured to transmit at least one transaction request based on the secret authorization information; and
wherein said transaction processor is configured to receive authorization information obtained from the consumer via the user interface, wherein said transaction processor determines whether the transaction is authorized based on a comparison between said authorization information and said secret authorization information.

21. The transaction authorization system of claim 20 wherein said transaction processor is configured to instruct the consumer to obtain said authorization information.

22. The transaction authorization system of claim 20 wherein said transaction processor is configured to determine whether to batch process a transaction along with a plurality of additional transactions based on a risk level identified in connection with the transaction, wherein transactions identified as having a substantial fraud risk are batch processed.

23. The transaction authorization system of claim 20 wherein in response to determining the transaction is authentic, said transaction processor communicates at least one of a private key associated with a digital currency address and a transaction request to transfer digital currency to an existing digital currency address.
